(19) United States
(12) Patent Application Publication
(10) Pub. No.: US 2011/0164859 A1
(43) Pub. Date: Jul. 7, 2011

(54) ELECTRONIC AUDIO/VIDEO STORY CONSTRUCTION METHOD

(76) Inventor: Kuang-Tsai Hao, Taipei (TW)

(21) Appl. No.: 12/652,055

(22) Filed: Jan. 5, 2010

(51) Int. Cl. H04N 5/91; H04N 5/93; H04N 5/92; G11B 27/00

(52) U.S. Cl. 386/290; 386/337

(57) ABSTRACT

An electronic audio/video story construction method includes the steps of providing an electronic video story category group having a plurality of electronic video story category units; providing a plurality of electronic video story groups connected to the electronic video story category units respectively, and the electronic video story groups have a plurality of electronic video story units respectively; and providing a plurality of electronic audio function groups coupled to the electronic video story units respectively, and each electronic audio function groups has a plurality of electronic audio playing units and an electronic audio recording unit, such that the electronic audio/video story construction method can facilitate users to select and view images of a desired story and listen to audios of the story.

### FIELD OF THE INVENTION

The present invention relates to an electronic audio/video story construction method, in particular to a method that facilitates users to select and view images of a desired story and listen to audios of the story.

### BACKGROUND OF THE INVENTION

Electronic audio/video story plays an important role in our daily life and provides us a way for conducting presentations, entertainments and learning In generally, we insert an optical disk containing a copyrighted electronic audio/video story into an optical disk player to view the electronic audio/video story, so that we can view images and listen to the audios of the story. If a user wants to view another electronic audio/video story, then the user has to change the optical disk. Obviously, such operation is very inconvenient to users. Furthermore, the optical disk is generally pre-recorded with a limited number of language versions, and is usually not recorded according to the language required by users.

Therefore, the present invention intends to disclose an electronic audio/video story construction method to facilitate users to select images of a desired story and listen to audios of the story.

### SUMMARY OF THE INVENTION

In view of the aforementioned shortcomings of the conventional way of playing an electronic audio/video story, the inventor of the present invention based on years of experience in the related industry to conduct extensive researches and experiments, and finally invented an electronic audio/video story construction method, in hope of achieving the effect of facilitating users to select images of a desired story and listen to audios of the story.

Therefore, it is a primary objective of the present invention to provide an electronic audio/video story construction method that uses an electronic video story category group, an electronic video story group and an electronic audio function group to facilitate users to select story images and corresponding story audios to achieve the effects of facilitating user to select images of a desired story and listen to audios of the story.

To achieve the foregoing objective, the present invention provides an electronic audio/video story construction method comprising the steps of:

(1) providing an electronic video story category group having a plurality of electronic video story category units;

(2) providing a plurality of electronic video story groups coupled to the electronic video story category units respectively, wherein the electronic video story groups have a plurality of electronic video story units respectively; and

(3) providing a plurality of electronic audio function groups coupled to the electronic video story units respectively, wherein each electronic audio function group has a plurality of electronic audio playing units and an electronic audio recording unit.

Therefore, the electronic audio/video story construction method of the invention can facilitate users to select and view images of a desired story and listen to audios of the story.

### BRIEF DESCRIPTION OF THE DRAWINGS

FIG. 1 is a flow chart of a preferred embodiment of the present invention; and

FIG. 2 is a schematic view of a procedure of a preferred embodiment of the present invention.

### DESCRIPTION OF THE PREFERRED EMBODIMENTS

To make it easier for the examiner to understand the objects, characteristics and effects of this invention, we use a preferred embodiment together with the attached drawings for the detailed description of the invention.

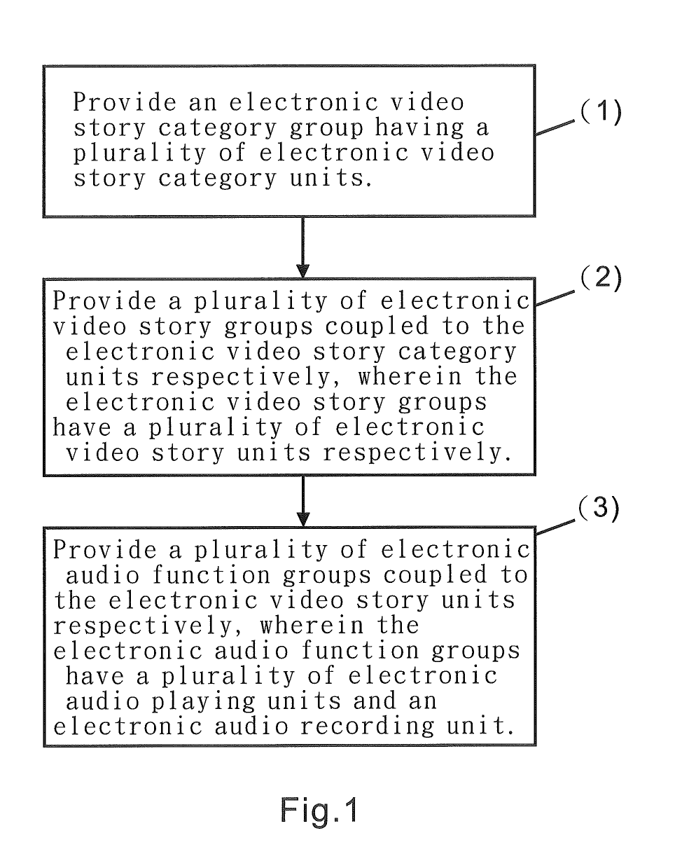

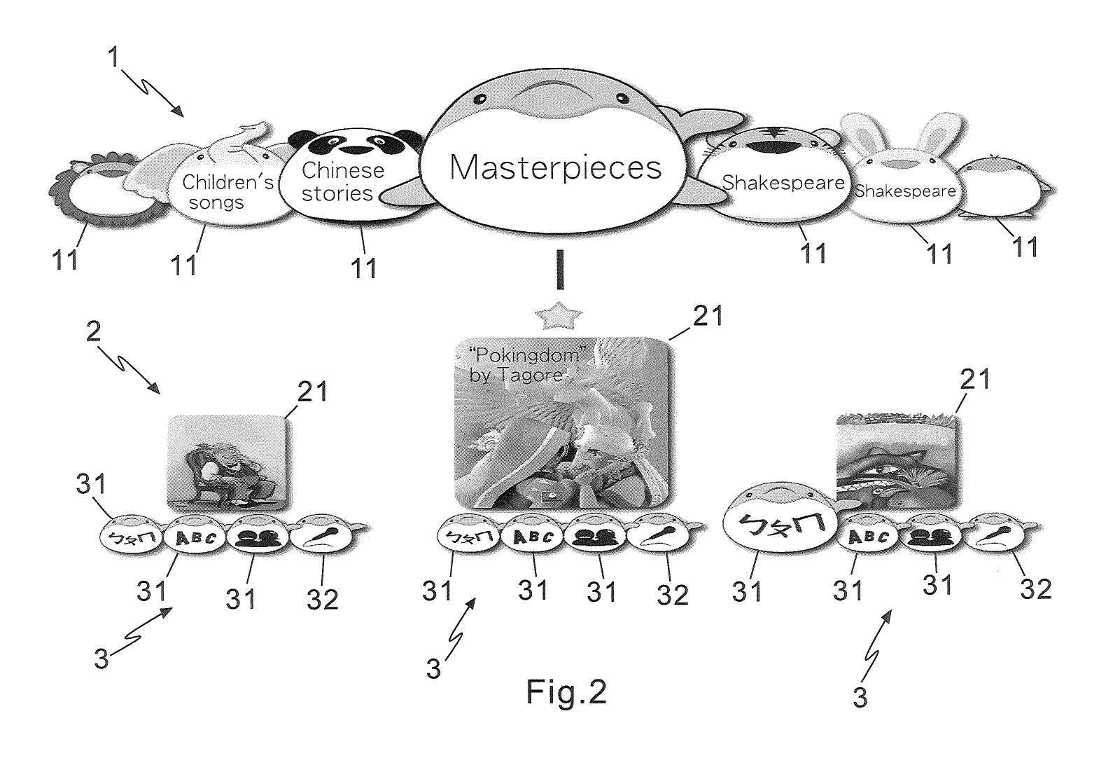

With reference to FIGS. 1 and 2 for a flow chart and a schematic view of a procedure in accordance with a preferred embodiment of the present invention respectively, an electronic audio/video story construction method of the present invention comprises the steps of:

(1) providing an electronic video story category group 1 having a plurality of electronic video story category units 11, wherein the electronic video story category units 11 can be Anderson's tales and stories, children's songs, Chinese stories, masterpieces, classics, Buddhism teachings, science and technologies, etc;

(2) providing a plurality of electronic video story groups 2 coupled to the electronic video story category units 11 respectively, wherein the electronic video story groups 2 include a plurality of electronic video story units 21 respectively, and the electronic video story units 21 can be “The Mammon and the Archer” by O Henry, “Pokingdom” by Tagore, and “The Story Teller” by Saki, etc; and

(3) providing a plurality of electronic audio function groups 3 coupled to the electronic video story units 21 respectively, wherein each electronic audio function group 3 includes a plurality of electronic audio playing units 31 and an electronic audio recording unit 32.

The aforementioned electronic audio player 31 can play a plurality of languages such as Mandarin, Taiwanese, Hakka dialect, aboriginal language, English, and Japanese, etc as well as a language pre-recorded by the electronic audio recording unit 32.

During an operation using the electronic audio/video story construction method of the present invention, a user selects a desired video story category unit 11 such as the “Masterpiece” from the electronic video story category group 1, and selects a desired electronic video story unit 21 such as the “Pokingdom” by Tagore from the electronic video story group 2 having the video story category unit 21, and then selects an electronic video player 31 from the electronic video function group 3 of the electronic video story unit 21 to listen to the audios of the story in a language such as Mandarin, and finally the user can view the images of the desired story, listen to the audios of the story, and view the subtitles corresponding to the audios of the story. In addition, the user can select the electronic audio recording unit 32 from the electronic audio function group 3 of the electronic video story unit 21, and then the user can view the images of the desired story and listen to the story in the desired audios, such that the user can select an electronic audio player to play the story in the language pre-recorded by the user.

The present invention integrates the plurality of electronic video story units 21 into a copyrighted electronic video story category group 1 and categorizes them, such that users can select images of a desired story conveniently. In addition, the present invention further provides the plurality of electronic audio playing units 31, such that the users can select to listen to the story in the desired audio (or language), and the present invention further provides the electronic audio recording unit 32, such that the users can record the story in a desired language, and the users can listen to the story in the desired recorded language.

In summation of the description above, the present invention uses the electronic video story category group, the electronic video story group, and the electronic video function group to allow users to select story images and corresponding story audios, so as to facilitate users to select and view images of a desired story and listen to the desired story. The products derived by the method of the invention can meet the market requirements, and thus the present invention complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. An electronic audio/video story construction method, comprising the steps of:
(1) providing an electronic video story category group having a plurality of electronic video story category units;
(2) providing a plurality of electronic video story groups coupled to the electronic video story category units respectively, and the electronic video story groups having a plurality of electronic video story units respectively; and
(3) providing a plurality of electronic audio function groups coupled to the electronic video story units respectively, and each of the electronic audio function groups having a plurality of electronic audio playing units and an electronic audio recording unit.

2. The electronic audio/video story construction method of claim 1, wherein the electronic audio playing units play the plurality of audio categories and also play an audio recorded by the electronic audio recording unit.
